(19) United States
(12) Patent Application Publication
(10) Pub. No.: US 2002/0150239 A1
(43) Pub. Date: Oct. 17, 2002

(54) Method for personalized encryption in an un-trusted environment

(75) Inventors: Ofir Carny, Kochav Yair (IL); Lidror Troyansky, Ramat Gan (IL)

Correspondence Address: G. E. EHRLICH (1995) LTD., c/o ANTHONY CASTORINA, SUITE 207, 2001 JEFFERSON DAVIS HIGHWAY, ARLINGTON, VA, 22202, US

(73) Assignee: Vidius Inc.

(21) Appl. No.: 10/122,309

(22) Filed: Apr. 16, 2002

Related U.S. Application Data
(60) Provisional application No. 60/283,949, filed on Apr. 17, 2001.

(51) Int. Cl. H04L 9/00

(52) U.S. Cl. 380/37; 713/176

(57) ABSTRACT

A method of encrypting digital content, the method is executed by at least one data processor and comprises selecting one or more segments of said digital content, duplicating said selected segment or segments, creating a plurality of copies of each segment and performing different encryption on said different copies.

### CROSS-REFERENCE TO RELATED APPLICATIONS

This application is related to and claims priority from U.S. Provisional Patent Application No. 60/283,949, filed Apr. 17, 2001, the contents of which are hereby incorporated herein by reference in their entirety.

### FIELD OF THE INVENTION

The present invention relates generally to the field of digital copyright protection and digital content encryption. More specifically, the present invention deals with personalized encryption of digital content in an un-trusted environment.

### BACKGROUND OF THE INVENTION

Illegal copying and distribution of digital content is prevalent in recent years, especially using the Internet. This illegal copying and distribution is an infringement of copyright protection laws and cause financial damages to tie rightful owners of the content. It is therefore of great interest to find methods that would stop or at least reduces illegal copying and distribution of digital content without offending rightful usage.

Methods for usage rights enforcement of digital media, digital rights management (DRM) and content protection are known. One of the most powerful building blocks in this respect is content encryption, where each of the copies of a given content is encrypted with a unique key and the keys are securely sent to rightful user. Using these methods, digital right management can be achieved by proper key management.

Other methods for digital rights management require that unique digital watermarks be embedded into each copy of the data at the data source, allowing for distribution of the data to be monitored for any unauthorized distribution. Embedding watermark into the media, in a manner that will not reduce tie quality of the media and yet will be robust to both malicious and non-malicious attacks requires the use of massive computational resources, such as CPU time and computer memory. If each copy of the media needs to be embedded with a different watermark, the amount of computational resources needed for the implementation of a large-scale distribution-system may become excessively large. U.S. patent application Ser. No. 09/772,518 filed Nov. 28, 2000 and PCT Patent Application No. IL01/00923, filed Oct. 3rd, 2001, describe a method for efficient on-line, real-time watermarking of video and/or audio and/or other digital content. The method, dubbed “watermark by selection”, is based on first selecting salient fractions of the content, whose removal will greatly reduce the quality of the content, then dividing each of the fragments to several segments. Each segment is then replicated N times, and each copy is marked with a different mark. Each replicated segment is viewed as an “alphabetic symbols”. On-line, real-time watermarking is based on first encoding the desired message using the above alphabetic symbols, and then, selection between alternative copies that correspond to the said symbols in order to produce the analog of the desired sequence of symbols.

In many cases, the content should be stored (e.g., in a proxy server, streaming server or a content distribution network) before it is distributed to the final user. Such servers or networks may not posses an adequate level of security and therefore may not be trustworthy. In such cases, the content should not reside unencrypted while stored in these servers. If one is going to employ key management for digital rights management, then it is required to send a content P that is encrypted with one key, Ks, {E_{Ks}(P)}, to multiple users, Uₗ, . . . U_{N}, such that each users will posses a special key, K₁, . . . K_{N}. Using current methods, one should either first decrypt die content using the key K_{S} and then re-encrypt the content using one of the keys K₁, . . . K_{N}, {Cᵢ=E_{Ki}(D_{Ks}(P))} or else encrypt the encrypted context, E_{Ks}(P), with the key Kᵢ and send the doubly-encrypted content, {Cᵢₛ=E_{Ki}(E_{Ks}(P))}, together with the two keys, K_{S} and Kᵢ, to the final user. The first method renders the content unencrypted before it is re-encrypted, while the second method supplies the final user the key K_{S}, which the user can thereafter send back to storage server. Furthermore, both methods require another encryption, which requires costly computational resources.

There is thus a recognized need for, and it would be highly advantageous to have, a method and system that allow personalized encryption of previously encrypted digital content, which will overcome the drawbacks of current methods as described above.

### SUMMARY OF THE INVENTION

The present invention seeks to provide a novel method for efficient on-line, real-time personalized encryption of digital content (e.g., video, audio, e-book, executable code etc.), that overcomes the drawbacks of methods that are based on re-encryption or double encryption described above. The method is based on first selecting at least one salient fraction of the content, whose removal will greatly reduce the quality of the content, and then dividing each of the fractions to several segments. Each segment Sⱼ is then replicated to N copies, S_{j,l}, . . . S_{j,N}, and each copy is encrypted with a special key, K_{j,n}, n=1 . . . N and is stored using a digital storage device. Each encrypted segment is regarded as an “alphabetic symbols” of an N-letter alphabet. A personalized subset of keys, called a “meta-key” Kᵢ is based on a unique message Mᵢ, that may corresponds to the details of the user. The message is first encoded using the above alphabetic symbols. Encrypted copy is produced by selecting between alternative copies in order to produce the desired sequence of symbols and sending the resulted sequence to the user. The personalized meta-key, Kᵢ, is the subset of keys, {Kⱼₙ} that were used for the encryption of the said selected segments. The meta-key can be sent to the final user using a secure channel. If each of the copies is also marked with a special steganogram that preferably cannot be perceived by human but can be detected by the embedded, then the personalized encrypted content also contain personalized watermark, or steganograms, as described in U.S. patent application Ser. No. 09/772,538, filed Nov. 28, 2000 and PCT Patent Application No. IL01/00923, filed Oct. 3rd, 2001. In this case, even if the user cooperates with the storage system in order to compromise the keys, the content that can be decrypted necessarily contain a personalized watermark, or a “fingerprint”, that can be used for forensic and breach analysis.

According to a first aspect of the present invention there is provided a method of encrypting digital content using at least one data processor and comprising:

Selecting at least one segment of the digital content;

Duplicating the at least one selected segment or segments, thereby creating a plurality of copies of each segment;

Performing different encryption on the plurality of copies.

In a preferred embodiment of the present invention, the different encryption comprises using different encryption keys for the plurality of copies.

In a preferred embodiment of the present invention, the method additionally comprises altering the plurality of copies after performing the selection and before performing the encryption.

In a preferred embodiment of the present invention, the altering the plurality of copies comprises performing different alterations on the different copies.

In a preferred embodiment of the present invention, the performing different alterations on the plurality of copies comprises watermarking the different copies and embedding different information in the plurality of copies.

In a preferred embodiment of the present invention, the watermarking and embedding different information in the plurality of copies comprises embedding information operable to be correlated to an identity of the recipient of the content.

In a preferred embodiment of the present invention, the distribution of the digital content comprises combining at least several of the copies of different segments and distributing the result of the combination and the copies are selected to be included in the combination so that the information stored in them is operable, when combined, to represent additional information operable to be correlated to an identity of a recipient of the digital content.

In a preferred embodiment of the present invention, there remains a portion of the digital content that was not selected in the selection of at least one segment of the digital content and the method additionally comprises selecting a subset of the encrypted copies, the subset being sufficient to reconstruct the digital content when decrypted and used together with the portion.

In a preferred embodiment of the present invention, the distribution of the digital content comprises combining the subset and the portion and distributing the product of the combining.

In a preferred embodiment of the present invention, the combining is performed by insertion of the segment in the subset into their original location in the portion.

In a preferred embodiment of the present invention, the distribution of the digital content comprises distributing the subset in an order that is different from the original order of the segments in the subset.

In a preferred embodiment of the present invention, the method additionally comprises selecting a subset of the encrypted copies, the subset selected for distribution and is sufficient when decrypted to be used to reconstruct the digital content.

In a preferred embodiment of the present invention, the distribution of the digital content comprises combining the subset and distributing the product of the combining.

In a preferred embodiment of the present invention, the distribution of the digital content comprises distributing the subset in an order that is different from the original order of the segments in the subset.

According to a second aspect of the present invention there is provided

a system for encrypting digital content comprising at least one data processor and designed and configured for:

Selecting at least one segment of the digital content;

Duplicating the at least one selected segment or segments, thereby creating a plurality of copies of each segment;

Performing different encryption on the plurality of copies.

In a preferred embodiment of the present invention, the system is additionally designed and configured for altering the plurality of copies after performing the selection and before performing the encryption.

In a preferred embodiment of the present invention, the altering the plurality of copies comprises performing different alterations on the plurality of copies.

In a preferred embodiment of the present invention, the performing different alterations on the plurality of copies comprises watermarking the plurality of copies and embedding different information in the plurality of copies.

In a preferred embodiment of the present invention, the watermarking and embedding different information in the plurality of copies comprises embedding information operable to be correlated to an identity.

In a preferred embodiment of the present invention, the identity is the identity of the recipient of the content.

In a preferred embodiment of the present invention, the distribution of the digital content comprises combining at least several of the copies of different segments and distributing the result of the combination and the copies are selected to be included in the combination so that the information stored in them is operable, when combined, to represent additional information operable to be correlated to an identity of a recipient of the digital content.

In a preferred embodiment of the present invention, the different encryption comprises using different encryption keys for the plurality of copies.

The present invention successfully addresses the shortcomings of the presently known method by providing a method and system for personalized encryption in a untrusted environment.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flowchart showing the sequence steps for pre-encryption of set of data segment, constructed and operative in accordance with a preferred embodiment of the present invention;

FIG. 2 is an illustration of the preparation of a set of data segments for encryption according to the method described in FIG. 1;

FIG. 3 is an illustration of is a simplified flow-chart describing the on-line encryption using personalized meta-keys, constructed and operative in accordance with a preferred embodiment of the present invention;

FIG. 4 illustrates a distribution system for distributing an encrypted digital content, constructed and operative in accordance with a preferred embodiment of the present invention;

FIG. 5 is a flowchart showing the sequence steps for marking and pre-encryption of a set of data segments, constructed and operative in accordance with a preferred embodiment of the present invention, and

FIG. 6 is an illustration of the preparation of a set of data segments for marking and encryption, according to the method described in FIG. 5;

### DETAILED DESCRIPTION OF PREFERRED EMBODIMENTS

The present invention seeks to provide a system and a method for on-line, real-time personalized encryption of digital content (e.g., video, audio, e-book, executable code etc.). The invention may be used as part of an on-line, real-time content distribution system, e.g. a video or audio on demand system operating over the Internet or some other network.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In a preferred embodiment of the present invention, the encryption method is based on first selecting, either manually or automatically, at least one salient fraction of the content, whose removal will greatly reduce the quality of the content, and then dividing each of the fractions to several segments. Each segment Sⱼ is then replicated to N copies, S_{j,l}, . . . S_{j,N}, and each copy is encrypted with a special key, K_{j,n}, n=1 . . . N. Each encrypted segment and each of the corresponding keys are regarded as a logical symbol of a N-letter alphabet. For example, a set associated with the various copies of the data segments may contain logical symbols “A”,“B” and “C,”. All the sets of pre-encrypted data segments are referred to as a library. A personalized subset of keys, referred to as “Meta-key” Kᵢ is produced based on a unique message Mᵢ; that may corresponds to the details of the user. The message is first encoded using the above alphabetic symbols. Encrypted personalized copy is produced by selecting between alternative copies in order to produce the desired sequence of symbols. The personalized meta-key, Kᵢ, is the subset of keys. {Kⱼₙ} that were used for the encryption of the selected segments. For example, within a multimedia data stream for an authorized user whose unique meta-key is “BAAC,” the first data segment within the salient fraction would be replaced with one of its encrypted copies that corresponds to the symbol “B,” the second segment would be replaced with one of its encrypted copies that corresponds to the symbol “A,” the third segment would be replaced with one of its encrypted copies that corresponds to the symbol “A,” and the fourth would be replaced with one of its encrypted copies that corresponds to the symbol “C.” The meta-key is preferably sent to the final user using a secure channel for decryption. If each of the copies is also marked with a special steganogram that cannot be perceived by human but can be detected by the embedded, then the personalized encrypted content may also contain personalized watermarks, or steganograms. In this case, even if the user cooperates with the storage system in order to compromise the keys, the content that can be decrypted necessarily contain a personalized watermark that can be used for forensic and breach analysis.

In a preferred embodiment of the present invention, the encryption of the various copies, which may be computationally demanding, is performed offline, in a batch mode, and the on-line personalized encryption requires only to select various encrypted copies to be sent to the final user, thereby saving computational resources.

With specific reference now to the drawings in detail, it is stressed that the particulars shown are by way of example and for purposes or illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the at least two forms of the invention may be embodied in practice.

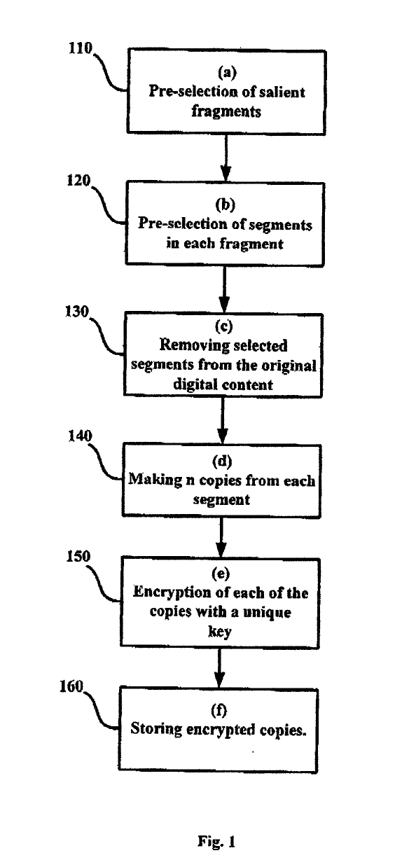

Turning now to FIG. 1, there is shown a block diagram of the steps for compiling each of the sets of replacement pre-encrypted data segments. These steps are usually performed “off-line”, where “off-line” means prior to the beginning of the distribution of the content over a network. Step (a) 110 is the “pre-selection of salient fragments” from the digital content, to be encrypted at some point in the future. The salient fraction is selected such that its removal from the content would cause a noticeable change or distortion in the content. Step (b) 120 is the “Pre-selection of segments in each fragment.” Each fragment may be partitioned into several segments of varying length. The number of segments to be selected in each fragment is related to the number of symbols that are being used for the construction of a “meta-key”. If, for example, the personalized meta-key is a ten character/symbol string (e.g. “kjhdfiuh23”), at least ten segments would be required. If the number of symbols in the personalized meta-key is not known in advance, the fragment may be partitioned into a number of segments sufficiently high to suit most contingencies, e.g. one hundred segments. These segments are preferably removed from the original content at stage (c) 130. For each segment selected, as part of step (d) 140, there are created a number of copies (n), where the number of copies (n) is at least as large as the size of the alphabet of unique symbols which may comprise the personalized key. For example, if the possible alphabet of symbols is [A, B, C, D and E], at least five copies of the data segment are made. As part of step (e) 150, each copy of the data segment is encrypted with a unique encryption key, corresponding to one of the symbols in the alphabet. Methods for encryption of digital content are well known, and any one of the known and not yet known methods may be used as part of the present embodiments. The encrypted copies are thereafter stored using any digital storage device (step (f), 160).

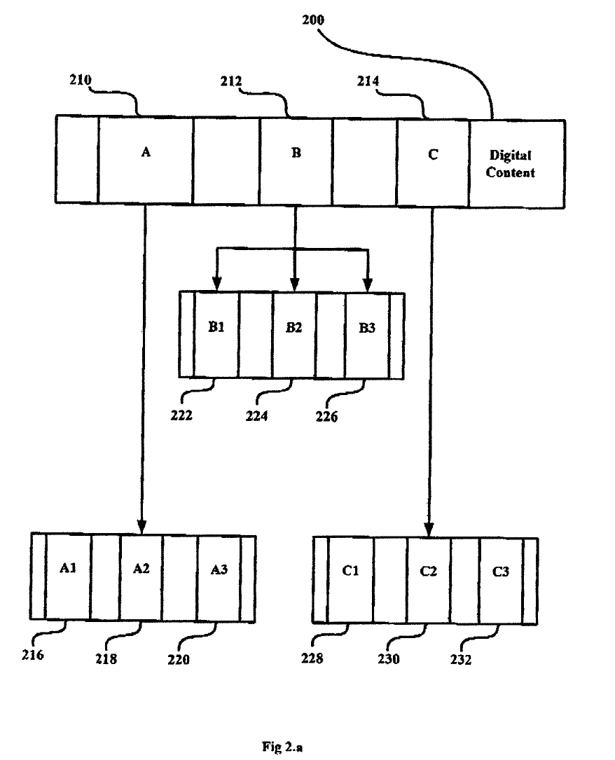

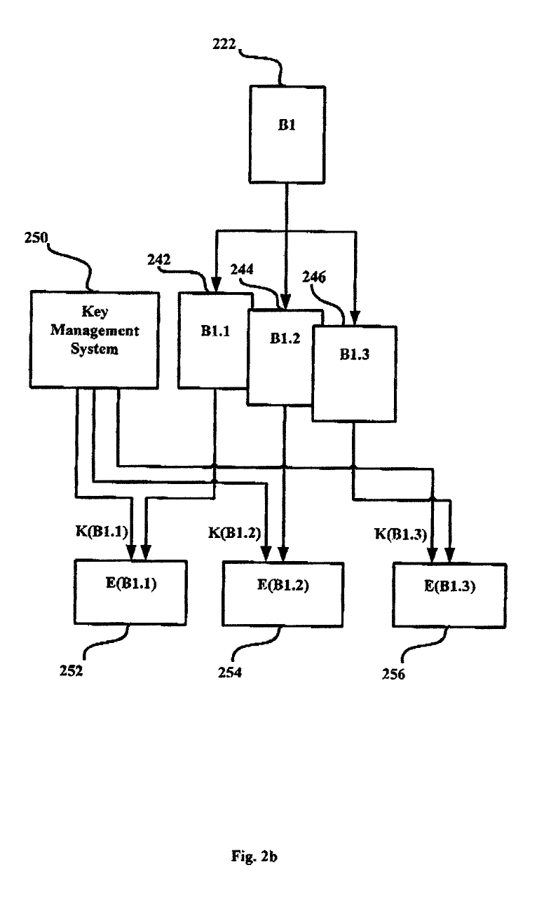

Turning now to FIG. 2, there is illustrated a pre-encryption system constructed and operative in accordance with a preferred embodiment of the present invention. In FIG. 2.a, a digital data stream or file 200, representing some digital content enters the systems and predetermined fragments A 210, B 212 and C 214 of the stream 200 are removed from the original content and selected for encryption. Each of the fragments is sub-divided into several segments. E.g., fragment B is sub-divided into segments B1 222, B2 224, and B3 226. The total number of segments in all the fragments is an upper bound for the length of the meta-key. In one embodiment of the present invention, each of the segments is thereafter replicated n times (n determines the size of the meta-key “alphabet”). In another embodiment of the present invention, each segment is replicated a different numbers of tires (i.e. have a “different alphabet”), this may be due to different saliency or size of the different segments, etc. In FIG. 2.b, n=3 and B1 is replicated 3 times to B1.1 242, B1.2 244 and B1.3 246. The key management system 250 produces individual encryption keys for each copy of each segment. Each copy of each segment is thereafter encrypted with the corresponding key, (encryption can be done using any known or as yet unknown encryption method, without substantially effecting any aspect of the present invention). In FIG. 2.b, B1.1 is encrypted using K(B1.1) to produce the ciphertext E(B1.1) 252. B1.2 is encrypted using K(B1.2) to produce the ciphertext E(B1.2) 254, and B1.3 is encrypted using K(B1.3) to produce the ciphertext E(B1.3) 256. The content, from which the original segments have been removed, together with the set of pre-encrypted copies of the segments, can thereafter be stored even in an un-trusted environment.

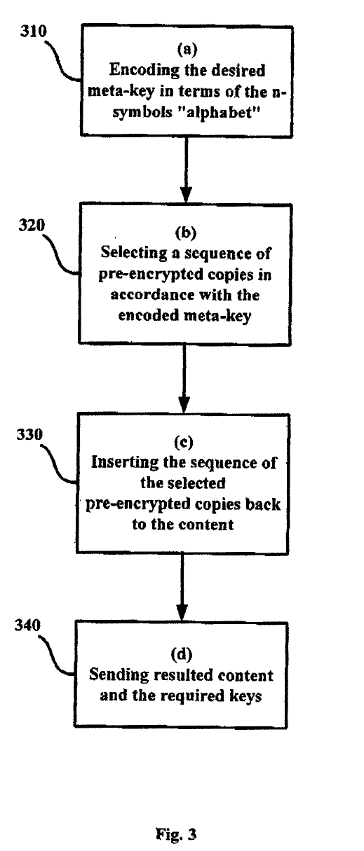

FIG. 3 describes the on-line personalized encryption: at stage (a) 310 the desired meta-key is encoded in terms of the n-symbol alphabet. At stage (b) 320, a sequence of preencrypted copies is selected in accordance with the encoded meta-key. At stage (c) 330, the selected sequence of the s pre-encrypted copies is inserted back into the content (from which the “plaintext” of the corresponding segments was removed). At stage (d) 340, the resulting content is sent to the user, together with the user personalized meta-key, Kᵢ, which is the subset of keys, {Kⱼₙ} that were used for the encryption can be sent to the final user, using a secure channel, for decryption of the segments.

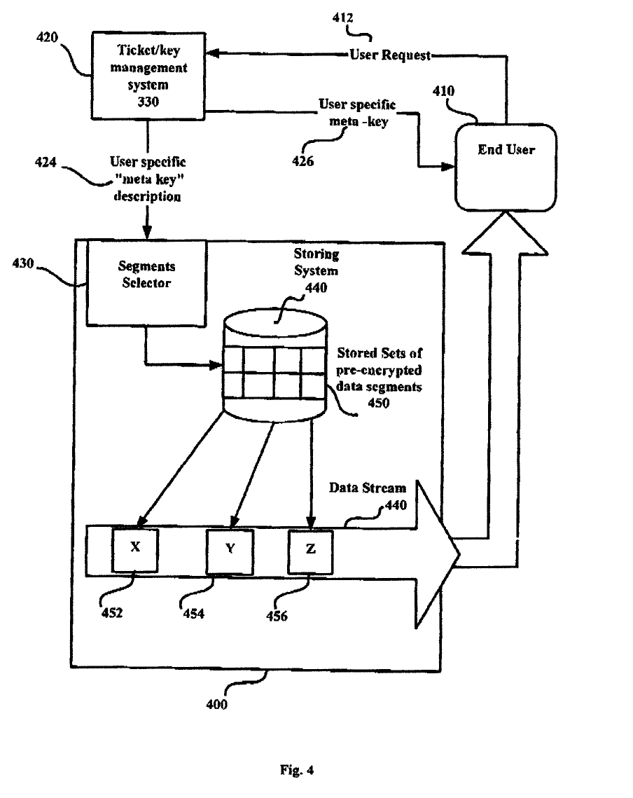

FIG. 4, illustrates a system for on line, personalized encryption of digital content, constructed and operative in accordance with a preferred embodiment of the present invention. In the system of FIG. 4, the user 410 is sending a request 412 to the ticket/key management system 420. The system sends a user specific meta-key 426 (i.e., the subset of keys that were used for the encryption) to the user 410, preferably using a secure channel. The ticket/key management system 420 also sends the description of the meta-key 424 to the segments selector 430 of the storing/encryption system 400. The selection subsystem then selects copies of pre-encrypted data segments from the storage 450. These copies are then inserted into their place in the data-stream (442, 444, 446). The data stream is thereafter sent to the user 410, who uses the keys contained in the meta-key 426 in order to decrypt the content.

In a preferred embodiment of the present invention each of the said copies is also marked with a unique steganogram or a watermark, that preferably cannot be perceived by human but can be detected by the embedder. In this case, while selecting a certain encrypted copy from each segment, the resulted sequence comprise a personalized encrypted content that also contain personalized watermark, or steganogram, which can be used for forensic and breach analysis, as described in U.S. patent application Ser. No. 09/772,538, filed Nov. 28, 2000 and PCT patent application No. IL01/00923, filed Oct. 3rd, 2001, the contents of which are hereby incorporated by reference. In this case, even if the user cooperates with the storage system in order to compromise the keys, the content that can be decrypted necessarily contains a personalized watermark that can be used for forensic purposes.

In another preferred embodiment of the present invention, metadata is similarly inserted into the content.

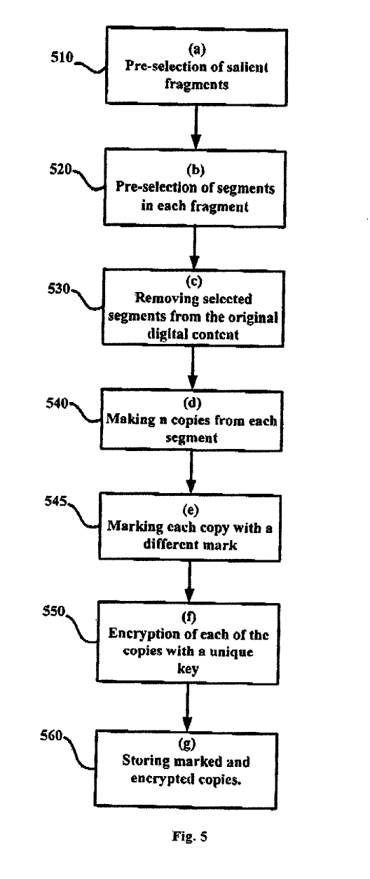

FIG. 5 is a flow-chart showing the sequence steps for marking and pre-encryption of a set of data segments, constructed and operative in accordance with a preferred embodiment of the present invention. Step (a) 510 is the “pre-selection of salient fragments” from the digital content, to be encrypted at some point in the future. The salient fraction is selected such that its removal from the content would cause a noticeable change or distortion in the content. Step (b) 520 is the “Pre-selection of segments in each fragment.” Each fragment may be partitioned into several segments of varying length. The number of segments to be selected in each fragment is related to the number of symbols that are being used for the construction of a “meta-key”. At stage (c) 530 these segments are removed from the original content. For each segment selected, as part of step (d) 540, there are created a number of copies (n), where the number of copies (n) is at least as large as the size of the alphabet of unique symbols, which may consist of the personalized key. For example, if the possible alphabet of symbols is [A, B, C, D and E], at least five copies of the data segment are made. As part of step (e) 545, each copy of the data segment is marked in a unique manner, corresponds to one of the symbols in the alphabet. Methods for watermarking digital content are well known, and any known or not yet known methods may be used as part of the present invention. As part of step (f) 550, each copy of the data segment is encrypted with a unique encryption key, corresponding to one of the symbols in the alphabet. The encrypted copies are thereafter stored using any digital storage device (step (g), 560).

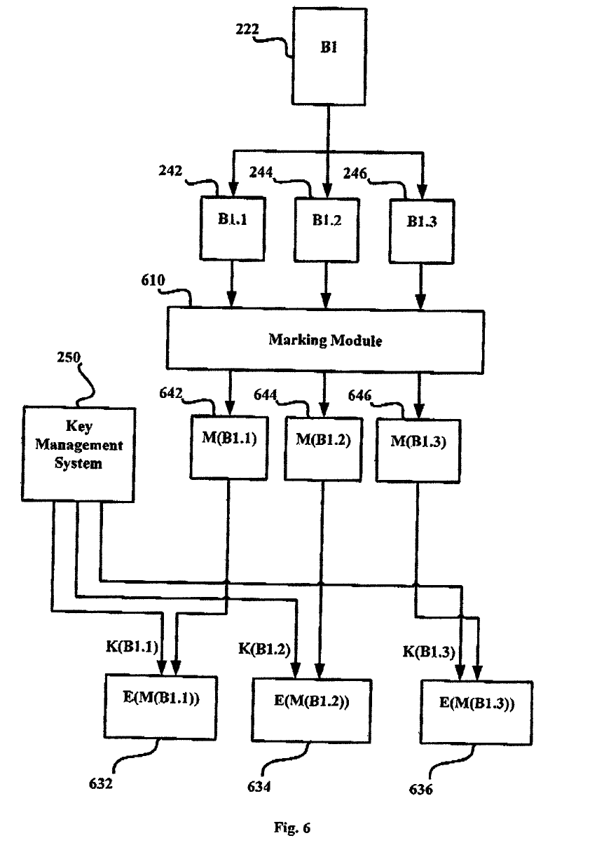

Turning now to FIG. 6, there is illustrated system for the preparation of a set of data segments for marking and encryption, according to the method described in FIG. 5. The system is substantially similar to the system described in FIG. 2: a segment B1 222 is duplicated several times (B1.1 242, B1.2 244 and B1.3 246). Each copy is then subjected to different marking using the marking module 610. The marking can be done by embedding a hidden message (steganogram) or by changing some of the data in each copy, in a manner that does not reduce the perceptual quality of the copy. Preferably, the marking should be robust against various attempts to remove the mark, commonly known as “attacks”. The marked copies, M(B1.1) 642, M(B(1.2) 644 and M(B(1.3)) 646 are then encrypted in different keys, provided by the key management system 250. The encrypted copies E(M(B1.1)) 632, E(M(B1.2)) 634 and E(M(B1.3)) 636 are then stored and are used for personalized encryption and distribution, preferably using the method and system described in FIG. 3 and 4. After the user assembles and decrypts, preferably using a dedicated module, the certain encrypted copies that were sent to him, the resulted set of copies contains a personalized watermark, or steganogram, which can be used for forensic and breach analysis, as described in U.S. patent application Ser. No. 09/772,538, filed Nov. 28, 2000 and PCT Patent Application No. IL01/00923, filed Oct. 3rd, 2001, the contents of which are hereby incorporated by reference. In this case, even if the user cooperates with the storage system in order to compromise the keys, the content that can be decrypted necessarily contains a personalized watermark that can be used for forensic purposes.

In a preferred embodiment of the present invention, the content comprises of at least one of the following: media content, media content containing an audio stream, media content containing a video stream, document, multimedia content, interactive content, software, data, information, slideshow, presentation.

In a preferred embodiment of the present invention, the content is stored in a compressed encoding.

In a preferred embodiment of the present invention, the digital content is encoded in MPFG compliant format such that each segment is bounded to a subset of the frames that contains at least one I-frame and all frames dependent on the I-frames it comprises of.

In a preferred embodiment of the present invention, the digital content is encoded in MPEG compliant format such that each segment is bounded to a subset of the frames that contains only I-frames.

In another preferred embodiment of the present invention, the information gathered by decoding previous sections is used in order to decode certain segments, thereby further enhance the security of this scheme. This method is especially effective if the segments are not decomposed only according to their sequential order, but also according to other criteria (eg. separate transmission of I-frames in MPEG format).

In another preferred embodiment of the present invention, several servers are used in order to transmit various segments, thereby further enhance the security of the method.

In another preferred embodiment of the present invention, the method additionally comprises encrypting the portion of the digital content not selected in the selection step.

In a preferred embodiment of the present invention, the digital content is encoded to several layers and the selection of segments comprises selecting the segments such that each segment is bounded to a subset of the layers.

In a preferred embodiment of the present invention, further comprising mapping the digital content to the lime domain and the selection of segments comprises selecting the segments such that each segment is bounded by time limits.

In a preferred embodiment of the present invention, further comprising mapping the digital content to a spatial domain and the selection of segments comprises selecting the segments such that each segment is bounded by spatial limits.

In a preferred embodiment of the present invention, further comprising mapping the digital content to frames and the selection of segments comprises selecting the segments such that each segment is bounded to a subset of the frames.

In a preferred embodiment of the present invention, the method additionally comprises encrypting a portion of the digital content not selected in the selection step.

It is appreciated that one or more steps of any of the methods described herein may be implemented in a different order than that shown, while not departing from the spirit and scope of the invention.

While the present invention may or may not have been described with reference to specific hardware or software, the present invention has been described in a manner sufficient to enable persons having ordinary skill in the art to readily adapt commercially available hardware and software as may be needed to reduce any of the embodiments of the present invention to practice without undue experimentation and using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein: are nevertheless within the true spirit and scope of the invention.

We claim:

1. A method of encrypting digital content using at least one data processor and comprising:
Selecting at least one segment of said digital content;
Duplicating said at least one selected segment or segments, thereby creating a plurality of copies of each segment;
Performing different encryption on said plurality of copies.

2. The method of claim 1 wherein said different encryption comprises using different encryption keys for said plurality of copies.

3. The method of claim 1, wherein said method additionally comprises altering said plurality of copies after performing said selection and before performing said encryption.

4. The method of claim 3, wherein said altering said plurality of copies comprises performing different alterations on said different copies.

5. The method of claim 4, wherein said performing different alterations on said plurality of copies comprises watermarking said different copies and embedding different information in said plurality of copies.

6. The method of claim 5, wherein said watermarking and embedding different information in said plurality of copies comprises embedding information operable to be correlated Lo an identity of the recipient of said content.

7. The method of claim 5, wherein the distribution of said digital content comprises combining at least several of said copies of different segments and distributing the result of said combination and wherein the copies are selected to be included in said combination so that said information stored in them is operable, when combined, to represent additional information operable to be correlated to an identity of a recipient of said digital content.

8. The method of claim 1, wherein there remains a portion of said digital content that was not selected in said selection of at least one segment of said digital content and wherein said method additionally comprises selecting a subset of said encrypted copies, said subset being sufficient to reconstruct said digital content when decrypted and used together with said portion.

9. The method of claim 8, wherein the distribution of said digital content comprises combining said subset and said portion and distributing the product of said combining.

10. The method of claim 9, wherein said combining is performed by insertion of said segment in said subset into their original location in said portion.

11. The method of claim 8, wherein the distribution of said digital content comprises distributing said subset in an order that is different from the original order of the segments in said subset.

12. The method of claim 1 wherein said method additionally comprises selecting a subset of said encrypted copies, said subset selected for distribution and is sufficient when decrypted to be used to reconstruct said digital content.

13. The method of claim 12, wherein the distribution of said digital content comprises combining said subset and distributing the product of said combining.

14. The method of claim 12, wherein the distribution of said digital content comprises distributing said subset in an order that is different from the original order of the segments in said subset.

15. A system for encrypting digital content, comprising at least one data processor and designed and configured for:
Selecting at least one segment of said digital content;
Duplicating said at least one selected segment or segments, thereby creating a plurality of copies of each segment;
Performing different encryption on said plurality of copies.

16. The system of claim 15, wherein said system is additionally designed and configured for altering said plurality of copies after performing said selection and before performing said encryption.

17. The system of claim 16, wherein said altering said plurality of copies comprises performing different alterations on said plurality of copies.

18. The system of claim 17, wherein said performing different alterations on said plurality of copies comprises watermarking said plurality of copies and embedding different information in said plurality of copies.

19. The system of claim 18, wherein said watermarking and embedding different information in said plurality of copies comprises embedding information operable to be correlated to an identity.

20. The system of claim 19, wherein said identity is the identity of the recipient of said content.

21. The system of claim 18, wherein the distribution of said digital content comprises combining at least several of said copies of different segments and distributing the result of said combination and wherein the copies are selected to be included in said combination so that said information stored in them is operable, when combined, to represent additional information operable to be correlated to an identity of a recipient of said digital content.

22. The system of claim 15, wherein said different encryption comprises using different encryption keys for said plurality of copies.
